(19) United States
(12) Patent Application Publication
(10) Pub. No.: US 2018/0198348 A1
(43) Pub. Date: Jul. 12, 2018

(54) MODULAR TIDAL AND RIVER CURRENT ENERGY PRODUCTION SYSTEM

(71) Applicant: Littoral Power Systems Inc., New Bedford, MA (US)

(72) Inventor: David Duquette, Monmouth Junction, NJ (US)

(21) Appl. No.: 15/520,685

(22) PCT Filed: Oct. 20, 2015
(86) PCT No.: PCT/US2015/056477

§ 371 Date: Apr. 20, 2017

Related U.S. Application Data
(60) Provisional application No. 62/065,963, filed on Oct. 20, 2014.

(51) Int. Cl. H02K 7/18; F03B 13/26; F03B 17/06

(52) U.S. Cl. CPC H02K 7/1823; F03B 13/264; F03B 17/061; F03B 17/062; F05B 2220/708; F05B 2260/02; F05B 2240/142; F05B 2240/40; F05B 2240/93; F05B 2250/25; F05B 2250/34; F05B 2230/6102

(57) ABSTRACT

In one embodiment, a system includes a shipping container holding a frame, and a plurality of assemblies attached to a surface of the frame. Each assembly of the plurality of assemblies includes a generator and a turbine coupled to the generator. The generator is configured to generate electricity in response to rotation of the turbine. One or more walls of the shipping container are removable to remove the frame from within the shipping container.

### CROSS-REFERENCE TO RELATED APPLICATIONS

The present application is a U.S. National Stage under 35 U.S.C. § 371 of International Application No. PCT/US2015/056477, filed Oct. 20, 2015, entitled “MODULAR TIDAL AND RIVER CURRENT ENERGY PRODUCTION SYSTEM”, and claims priority to and the benefit of U.S. Provisional Patent Application No. 62/065,963, filed Oct. 20, 2014, entitled “MODULAR TIDAL AND RIVER CURRENT ENERGY PRODUCTION SYSTEM “, the entire contents of which are incorporated herein by reference for all purposes.

### TECHNICAL FIELD

The present application relates generally to systems and methods for energy production in bodies of water. More specifically, the present application relates to a modular tidal and river current energy production system.

### BACKGROUND

Ocean renewable tidal and ocean current energy systems provide an enormous global opportunity for a clean carbon-free energy future. Demand is extremely high for systems which are environmentally safe, pay for themselves quickly, are easily transported, and can be widely deployed.

Many coastal areas around the world are off-grid or have poor electrical power infrastructure. In addition, these areas are also in frequent need of emergency power systems. For these areas, it is vital to create systems that provide steady, reasonably constant output.

Tidal and river current power is a desirable choice for these areas for the following reasons: tidal and most river currents are entirely predictable; tidal and river currents are efficient and reliable sources of power; submarine conditions are unaffected by surface weather; tidal and river current energy systems have almost no visual or environmental impacts; power is relatively easy to harvest from moving water because it is approximately 880 times denser than air.

While tidal and river power provides great opportunities, there are also a number of challenges. Submarine currents produce tremendous forces that act directly on power harvesting equipment when in-current, making structural integrity crucial. The saltwater environment is extremely harsh and corrosive. Marine growth can be rapid, and can foul systems and reduce efficiency very quickly. Proximity of electrical equipment to salt water calls for great care in transmitting high-current electrical power. In addition, all energy-harvesting systems require maintenance, and the environment makes access extremely difficult.

Existing systems typically consist of massive pieces of equipment that are extremely expensive to manufacture, transport, install, and maintain. They tend to require significant water depth and impact the maritime environment because of their sheer size. Many existing systems protrude above the surface of the water, impairing surface navigation. These systems do not scale well, and are only appropriate for a small number of locations.

### SUMMARY

In view of the above, the present solution provides a highly modular, flexibly deployed tidal and river current energy system that is low-cost, easy to transport, install, and maintain, and is highly scalable, allowing high energy production at reasonable costs from a range of sites. Various embodiments disclosed herein provide systems and methods for modular tidal and river current energy production that can be deployed and effectively operate in otherwise difficult locations and applications.

In one embodiment, a system includes a shipping container holding a frame, and a plurality of assemblies attached to a surface of the frame. Each assembly of the plurality of assemblies includes a generator and a turbine coupled to the generator. The generator is configured to generate electricity in response to rotation of the turbine. One or more walls of the shipping container are removable to remove the frame from within the shipping container.

In some embodiments, the frame is further configured to be removed from the shipping container and installed securely underwater to a sea floor and to generate power via water flowing through the turbine of each of the plurality of assemblies.

In some embodiments, the frame further includes a frame to footing connection mechanism to connect the frame to footing caps installed on the sea floor.

In some embodiments, the footing caps are configured to be attached to pilings.

In some embodiments, the frame further includes an underwater make and break electrical connection and an electrical junction box to transmit power generated by the generator of each of the plurality of assemblies to a point on shore.

In some embodiments, each assembly is further configured to be modular and removable such that the electrical junction box receives power from the plurality of assemblies independent of one another.

In some embodiments, the frame further includes a plurality of vertical members coupled to a plurality of horizontal members, one or more diagonal struts along one or more ends of the frame, and one or more upper supports to hold the plurality of assemblies in place within the frame.

In some embodiments, the assemblies are one of vertically or horizontally oriented within the frame.

In some embodiments, the turbine includes one of a cross flow turbine or an axial turbine.

In some embodiments, the frame is further configured to be removed from the shipping container and suspended from a barge underwater to generate power via water flowing through the turbine of each of the plurality of assemblies.

In some embodiments, the frame is further configured to be removed from the shipping container and installed at least partially underwater from one of a bottom of a moored barge, attached to a river abutment, attaching to mooring anchors or attached to helixes installed in the sea bed.

In one embodiment, a method includes receiving a shipping container. The shipping container includes a frame having a plurality of assemblies attached to a surface of the frame. Each assembly of the plurality of assemblies includes a generate and a turbine coupled to the generator. The generator is configured to generate electricity in response to rotation of the turbine. The method includes removing the frame from within the shipping container by removing one or more walls of the shipping container. The method includes installing the frame at least partially underwater by securing the frame to a support structure using a connection mechanism. Water flowing through the turbine of each of the assemblies causes rotation of the turbine and generation of electricity.

In some embodiments, securing the frame to the support structure using the connection mechanism includes suspending the frame from a barge underwater.

In some embodiments, securing the frame to the support structure using the connection mechanism includes attaching the frame to at least one of a river abutment, a bridge abutment, mooring anchors, or helixes installed in a sea bed.

In some embodiments, securing the frame to the support structure includes securing the connection mechanism to footing caps installed on the sea floor.

In some embodiments, the method further includes transmitting power generated by the generator of each of the plurality of assemblies to a point on shore via an electrical junction box and an underwater make and break electrical connection.

In some embodiments, the method further includes detaching an assembly from the frame and continuing to transmit power generated by the generators of the remaining assemblies.

In some embodiments, installing the frame further includes positioning the frame subject to at least one of tidal or current flow.

In some embodiments, the turbine includes one of a cross flow turbine or an axial turbine.

In some embodiments, the assemblies are one of vertically or horizontally oriented within the frame.

It should be appreciated that all combinations of the foregoing concepts and additional concepts discussed in greater detail below (provided such concepts are not mutually inconsistent) are contemplated as being part of the inventive subject matter disclosed herein. It should be appreciated that terminology explicitly employed herein that may also appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a block diagram of a modular tidal and river current energy production system, in accordance with one embodiment.

FIG. 2 is a perspective view of a shipping container, in accordance with one embodiment.

FIG. 3 is a perspective view of a modular tidal and river current energy production system, in accordance with one embodiment.

FIG. 4 is a perspective view of the system of FIG. 3 having an electrical connection for transmitting energy, in accordance with one embodiment.

FIG. 5 is a top perspective view of the system of FIG. 3, in accordance with one embodiment.

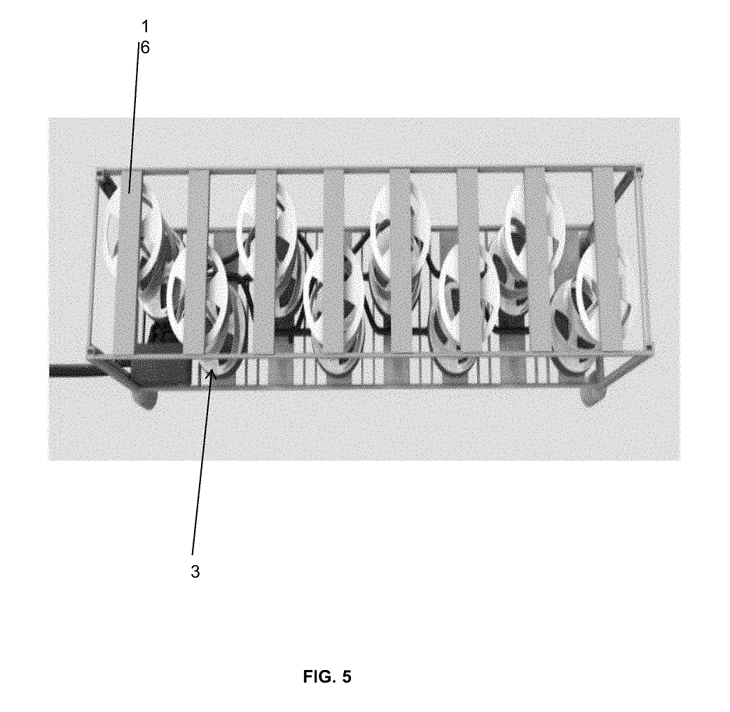

FIG. 6 is a perspective view of the system of FIG. 3 and water flow, in accordance with one embodiment.

FIG. 7 is a perspective view of two modular tidal and river current energy production positioned adjacent to one another, in accordance with one embodiment.

FIG. 8 is a perspective view of an assembly for a modular tidal and river current energy production system, in accordance with one embodiment.

FIG. 9 is a perspective view of a modular tidal and river current energy production system positioned on a sea shelf, in accordance with one embodiment.

FIG. 10 is a perspective view of modular tidal and river current energy production systems suspended from a barge, in accordance with one embodiment.

FIG. 11 is a perspective view of an arrangement of tidal power units for a modular tidal and river current energy production system, in accordance with one embodiment.

FIG. 12 is a front perspective view of an arrangement of tidal power units for a modular tidal and river current energy production system, in accordance with one embodiment.

FIG. 13 is a front perspective view of the arrangement of FIG. 12 in a channel, in accordance with one embodiment.

FIG. 14 is a front perspective view of an arrangement of modular tidal and river current energy production systems having cross flow turbines on a sea floor, in accordance with one embodiment.

FIG. 15 is a schematic diagram of converting a shipping container into a modular tidal and river current energy production system, in accordance with one embodiment.

FIG. 16 is a schematic diagram of performing maintenance on a modular tidal and river current energy production system, in accordance with one embodiment.

FIG. 17 is a perspective view of a modular tidal and river current energy production system utilizing axial turbines, in accordance with one embodiment.

FIG. 18 is a perspective view of an arrangement of the systems of FIG. 17, in accordance with one embodiment.

FIG. 19 is a bottom perspective view of a remotely operated underwater vehicle performing maintenance on the arrangement of FIG. 18, in accordance with one embodiment.

FIG. 20 is a detailed perspective view of the remotely operated underwater vehicle performing maintenance on the arrangement of FIG. 18, in accordance with one embodiment.

FIG. 21 is a perspective view of deploying the system of FIG. 17, in accordance with one embodiment.

FIG. 22 is a flow diagram of a method of producing energy, in accordance with one embodiment.

The features and advantages the inventive concepts disclosed herein will become more apparent from the detailed description set forth below when taken in conjunction with the drawings.

### DETAILED DESCRIPTION

Following below are more detailed descriptions of various concepts related to, and embodiments of, inventive systems, methods and apparatus for accessing and manipulating luggage. It should be appreciated that various concepts introduced above and discussed in greater detail below may be implemented in any of numerous ways, as the disclosed concepts are not limited to any particular manner of implementation. Examples of specific implements and applications are provided primarily for illustrative purposes.

Referring to the figures generally, various modular tidal and river current energy production systems are disclosed that are low-cost, easy to transport, install, and maintain, and highly scalable so that power can be produced across a wide range of installation sites. In some embodiments, a system includes a shipping container holding a frame, and a plurality of assemblies attached to a surface of the frame. Each assembly includes a generator and a turbine coupled to the generator. The generator is configured to generate electricity in response to rotation of the turbine. One or more walls of the shipping container are removable to remove the frame from within the shipping container. In some embodiments, the frame is configured to be removed from the shipping container and installed securely underwater to a sea floor and to generate power via water flowing through the turbine of each of the plurality of assemblies. In some embodiments, the frame further includes an underwater make and break electrical connection and an electrical junction box to transmit power generated by the generator of each of the plurality of assemblies to a point on shore. When a system is placed in a channel or anywhere with current or tidal flow it can generate energy. As water flows through the system is causes the turbines to rotate. This rotation is transmitted to the generator and energy is captured. In some embodiments, a cross flow turbine is selected for this type of application because it is equally efficient no matter what direction the water is moving so in a tidal situation it can generate power anytime water is moving. In some embodiments, the system is modular. Individual assemblies, or components of the assemblies, may be removed from the system without affecting energy generation by other assemblies. For example, assemblies may be removed for repair, maintenance, upgrading, or replacement.

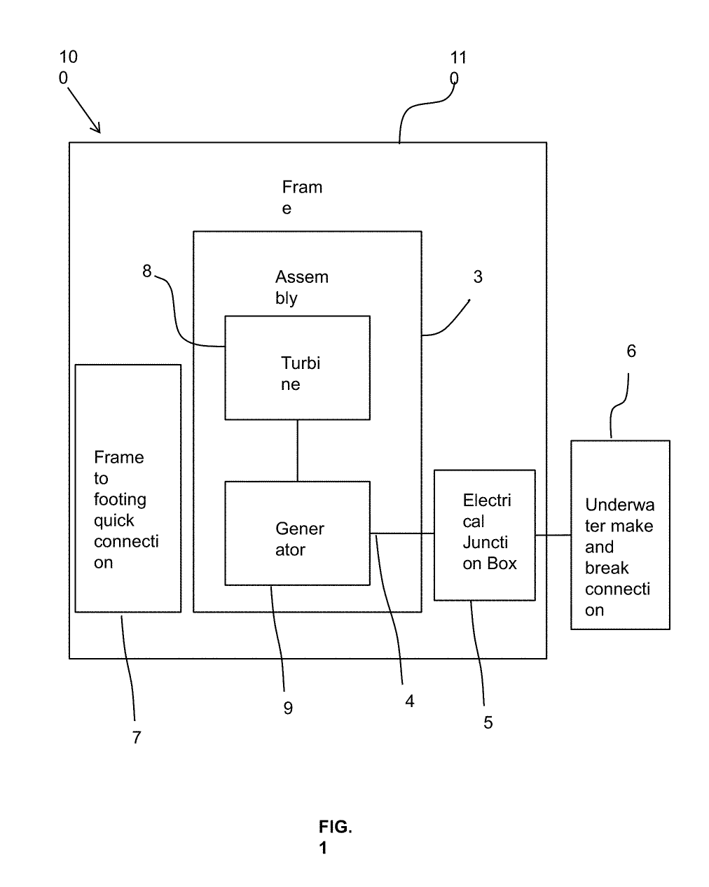

Referring now to FIG. 1, an embodiment of a system 100 (e.g., a modular tidal and river current energy production system) is shown. The system 100 includes a frame 110. The frame 110 provides a structure for supporting an assembly 3. The frame 110 may be configured to withstand forces from being positioned underwater, while allowing for water to flow to the assembly 3. The system 100 may be a shipping container that includes, encloses, carries, holds or secures the frame 110. The shipping container may be used to carry the frame to location of deployment or installation, at which the frame is installed or secured to generate power or energy as described herein. In some aspects, the system may be referred to as a single energy production unit.

The assembly 3 includes a turbine 8 and a generator 9. The turbine 8 is configured to be rotated by water flowing through the frame 110 and through the turbine 8. The generator 9 is configured to generate electricity in response to rotation of the turbine 8. In some embodiments, the assembly 3 is attached to a surface of the frame 110. In some embodiments, the system 100 includes a plurality of assemblies 3.

In some embodiments, the turbine 8 is a cross flow turbine. The cross flow turbine 8 may be rotated by water flowing through the cross flow turbine 8 independent of the direction of the water flow. In some embodiments, the turbine 8 is an axial (e.g., fan type) turbine. The axial turbine 8 may include turbine blades that are pitched to be rotated by water flowing through the axial flow turbine 8.

The system 100 includes an electrical junction box 5 that is electrically connected via electrical connections 4 to the generator 9 to receive electricity generated by the generator 9. The electrical junction box 5 may transmit the electricity received from the generator 9 to an underwater make and break connection 6. In some embodiments, the underwater make and break connection is part of the electrical junction box 5. The underwater connection enables each unit to transmit power to the shore or other collection point. Electricity generated by the system 100 may be transmitted to a point on shore via the electrical junction box 5 and the make and break connection 6. The electricity transfer components, such as the generator 9, the electrical connections 4, the electrical junction box 5, and the make and break connection 6, may be electrically insulated, or otherwise sealed, to protect the electrical connections from the surrounding water environment.

The frame 110 is configured to be installed securely underwater. In some embodiments, the frame 110 includes a connection mechanism 7, such as a frame to footing quick connection. The frame to footing quick connection allows the frame 110 to be secured to a support structure, such as a piling driven into an underwater bed.

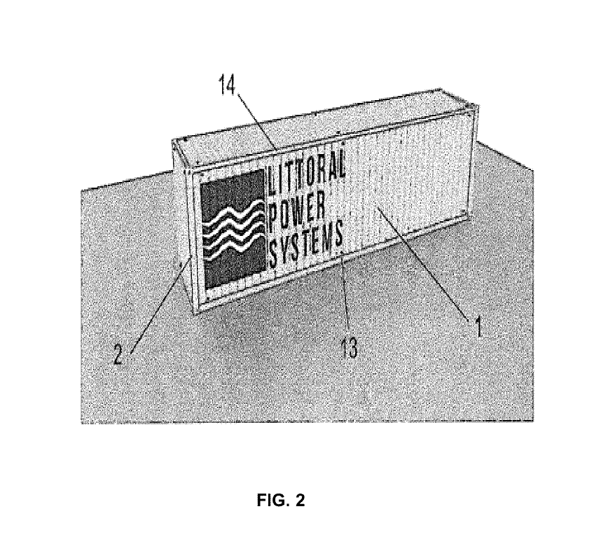

Referring now to FIG. 2, a shipping container 1 is shown. FIG. 2 shows the transportation configuration of a single power generation or energy production unit. The shipping container 1 may be modified to provide a modular hydrokinetic energy system (e.g., system 100 shown in FIG. 1, etc.). The shipping container 1 includes vertical members 2 and horizontal members 14. Walls of the shipping container 1 are coupled between the vertical members 2 and horizontal members 14, such as at the container wall fastening point 13 coupling the wall to the horizontal members 14.

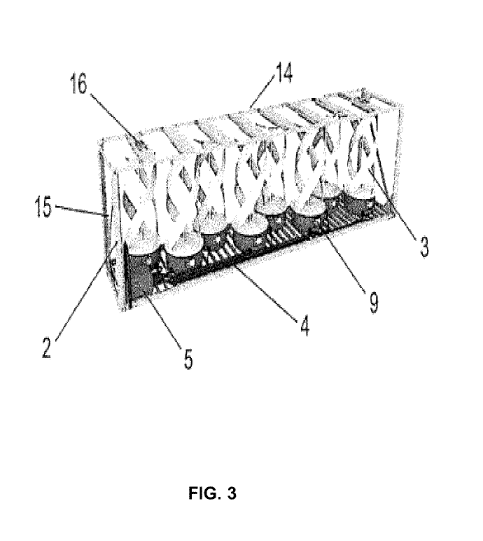

The shipping container 1 may be of any desired type, size, configuration, material(s) and/or construction, such as, without limitation, a “recycled” ISO shipping container or a custom manufactured container; rectangular, cylindrical or any other desired shape; or any metals (aluminum, steel, stainless steel, titanium, magnesium, etc.), plastics (nylon, glass-filled nylon, acetal, polypropylene, ABS, etc.), composites (carbon fiber), resin stainless steel, aluminum, bronze or any other desired materials, etc. As shown in FIG. 2, the reinforced ISO shipping container frame is made up of vertical members 2, horizontal members 14, diagonal struts along the ends of the container, and upper turbine supports that enable the cross flow turbine and generator assemblies to be held in place (e.g., diagonal struts 15, upper turbine supports 16 shown in FIG. 3). The cross flow turbine and generator assemblies are vertically oriented and spaced in such a way as to maximize energy capture.

The walls of the shipping container 1 are removable to remove the frame from within the shipping container 1. This provides a modular, scalable energy production system in which shipping containers 1 carrying assemblies (e.g., assembly 3 shown in FIG. 1, etc.) can be transported using standardized shipping methods to various locations, including locations inaccessible to massive energy systems.

In some embodiments, the transportation or shipping configuration of the shipping container 1 is designed to match a standard ISO shipping container in order to benefit from the wide variety of shipping methods that are tailored to transporting ISO containers. In some embodiments, the system 100 is built into an actual ISO shipping container where the welded walls have been removed, the internal frame is modified, and then the walls are put back in via the container wall fastening points 13. In such embodiments, the vertical members 2 and horizontal members 14 may be reinforced with diagonal struts 15 and upper supports 16, as shown, for example, in FIG. 3.

The shipping container 1 may be deployed in a variety of manners, such as by using a crane or tender on a ship to deploy the shipping container 1 underwater. The shipping container 1 may be deployed to ultimately position a frame of the shipping container 1, such as positioning the shipping container 1 subject to at least one of tidal or current flow.

In some embodiments, the system 100 is provided by custom building frames from scratch that can be treated and tied down in a manner similar to an ISO shipping container would be during shipping. In various embodiments, various sizes of ISO shipping containers or custom frames may be provided, including different size potentially nonstandard size containers. The container sizing may depend on the conditions at which the system 100 may be deployed.

Referring now to FIGS. 37, an embodiment of the system 100 is shown including a frame (e.g., frame 110 shown in FIG. 1) defined by components including vertical members 2, horizontal members 14, diagonal struts 15, and upper supports 16. As shown in FIG. 2, the vertical members 2, horizontal members 14, diagonal struts 15, and upper supports 16 are coupled to form a substantially rectangular solid form.

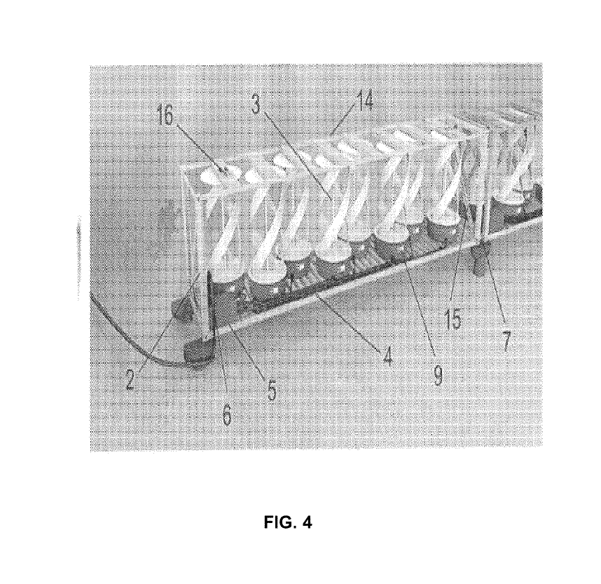

In some embodiments, the system 100 includes a plurality of assemblies 3. The plurality of assemblies 3 are attached to a surface of the frame (e.g., a surface defined by horizontal members 14). The generator 9 of the assembly 3 may be attached to a first surface of the frame, and the turbine 8 of the assembly 3 may be attached to upper supports 16 spaced apart from the surface of the frame and extending between the horizontal members 14, and parallel to the surface of the frame. The upper supports 16 enable the assemblies 3 to be held in place. The assemblies 3 are shown to be vertically oriented and spaced in such a way as to maximize energy capture. The plurality of assemblies 3 may vary in number. For example, the plurality of assemblies 3 may include between one and eight assemblies 3. The plurality of assemblies 3 may be arranged in line, in separate lines, in staggered lines (e.g., as shown in FIGS. 4, 6, and 7), or other arrangements to maximize the power generated by the system 100. In some embodiments, the orientations and/or positions of the assemblies 3 are variable. For example, the frame may include more attachment points than assemblies 3, such that the assemblies 3 can be attached in varying positions and/or orientations relative to the frame.

The electrical junction box 5 receives electricity from each generator of the plurality of assemblies 3 via the electrical connections 4. The electrical junction box 5 may be electrically connected to the underwater make and break electrical connection 6 for transmitting the electricity generated to a point on shore.

In some embodiments, the plurality of assemblies 3 are modular. Each assembly 3 is configured to be modular and removable such that the electrical junction box 5 receives power from the plurality of assemblies independent of one another. Detaching, decoupling, or otherwise removing one or more assemblies 3 will not affect the electricity transmission of the other assemblies 3—the system 100 will continue to transmit power generated by the generators 9 of the remaining assemblies 3. As shown in FIGS. 4, 6, and 7, the plurality of assemblies 3 are staggered, helping to maximize the energy captured by water flowing through the system 100. As such and in some aspects, each assembly may be considered like a cartridge or unit that can be connected to the frame and put into production use independently of another assembly and/or disconnected from the frame and removed and replaced independently of another assembly.

The frame to footing quick connection 7 allows the system 100 to be secured to a support structure. For example, the frame to footing quick connection 7 shown in FIGS. 4 and 6-7 is secured to footing caps in an underwater surface such as a sea floor. The frame to footing quick connection 7 thus ensures that the frame of the system 100 remains stable in response to forces generated by water flowing through and by the system 100, such that the turbines undergo maximum rotation due to the flowing water. The specially designed footing caps may be attached to steel piling (or other suitable material(s)) that are installed in the sea floor that enable the system 100 to be secured in place through the frame to footing quick connection mechanism 7 that utilizes the built in quarter turn quick-connection system already present on the ISO shipping container frame.

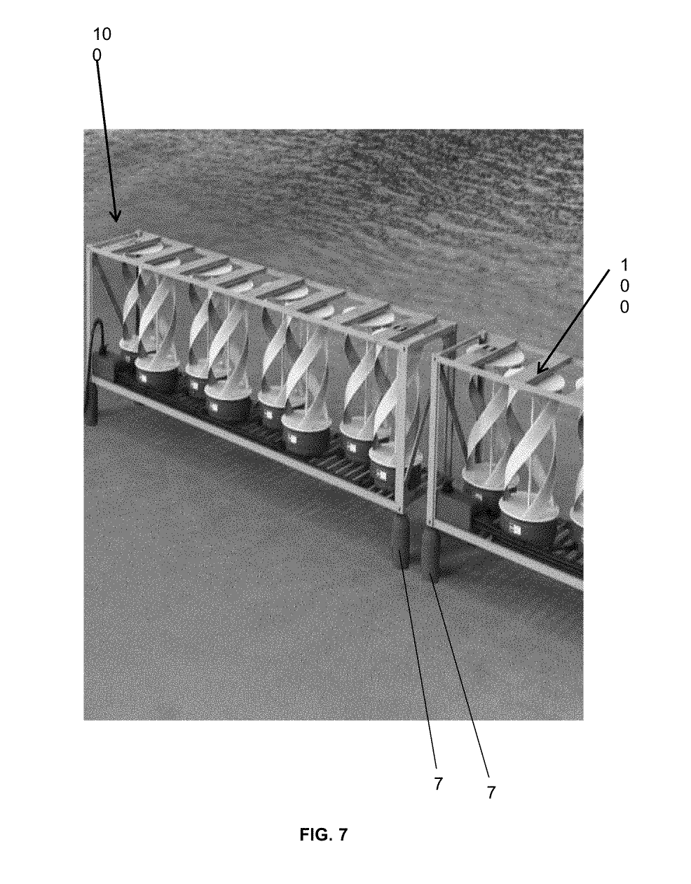

As shown in FIG. 4, two systems 100 have been secured to the footing cap using frame to footing quick connections 7. The frame to footing quick connections 7 thus provide modularity to the system by allowing flexibility in how the systems 100 can be arranged and secured to a support structure. Each footing may be able to accommodate any desired number of systems 100, such as two systems 100, so that units can be arrayed. In some embodiments, such as shown in FIG. 7, the systems 100 may be arrayed without sharing footings.

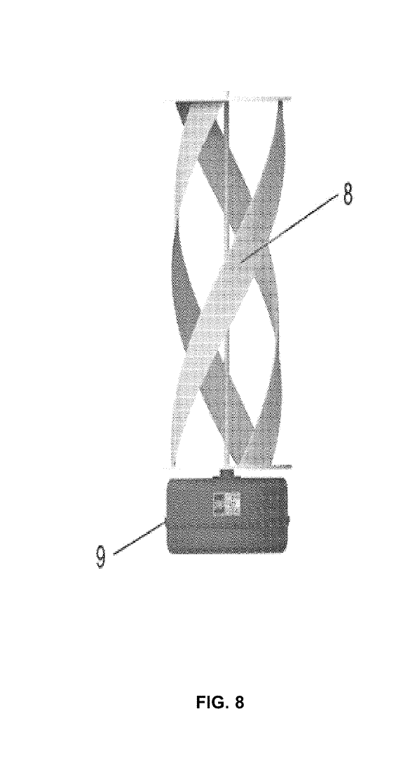

Referring now to FIG. 8, an embodiment of the turbine 8 is shown to include a cross flow turbine 8. The assembly is made up of two primary elements: the cross-flow turbine 8 and the axial flux generator 9. The cross flow turbine 8 may be rotated independently of the direction of water flowing through the cross flow turbine 8. Rotating the cross flow turbine 8, which is mechanically coupled to the generator 9, causes the generator 9 to generate electricity. For example, the cross flow turbine 8 may include a shaft mechanically coupled to or integral with a rotor of the generator 9, or otherwise be coupled to or integral with a rotor of the generator 9, so that rotating of the cross flow turbine 8 causes the generator 9 to generate electricity. When the system 100 is placed in a channel or anywhere with current or tidal flow it can generate energy. As water flows through the system 100 and the turbine 8, it causes the turbine 8 to rotate. This rotation is transmitted to the generator 9 and energy is captured. The cross flow turbine 8 can be equally efficient no matter what direction the water is moving so in a tidal situation it can generate power anytime water is moving. In various embodiments, various types and orientations of turbines 8 may be provided.

In some embodiments, the generator 9 is optimized to minimized vertical height, and is located directly beneath the turbine 8. In some embodiments, the generator 9 is an axial flux generator 9. Portions of the generator 9 can be built directly into a bottom plate of the bottom of the turbine bottom 8, reducing the vertical height of the generator 9.

In some embodiments, the turbine 8 may include three or more blades in a helical or straight configuration. The turbine 8 may include a center shaft of varying diameters, such as large diameter or small diameter. In some embodiments, no center shaft is provided. The blades and end caps of the turbine 8 may be coated with a growth-inhibiting or self-cleaning coating. Such a coating facilitates deployment of the system 100 in conditions otherwise unsuitable to turbine operation, while reducing maintenance expenditures. As shown in FIG. 3, each assembly 3 in a single system 100 is wired to the electrical junction box 5.

In some embodiments, the turbine 8 does not include a top or bottom plate, but instead includes a plurality of blades supported by a central shaft. In some embodiments, the system 100 includes a plurality of assemblies 3 having turbines 8 with varying features. For example, one or more of the turbines 8 may include a first design or configuration optimized for water flow having relatively low velocity, and others of the turbines 8 may include a second design or configuration optimized for water flow having relatively high velocity.

In some embodiments, the generator 9 is integrated into the turbine 8. For example, an end plate of the turbine 8 may provide a rotor of the generator 9.

In some embodiments, the rotor of the generator 9 is direct-driven by the turbine. In some embodiments, the rotor of the generator 9 is coupled to the turbine 8 via a gear mechanism, so that the rotor of the generator 9 rotates at a different rate than the turbine 8.

In some embodiments, the generator 9 is fully integrated into the turbine 8. For example, the generator 9 may be integrated into a spindle or shaft of the turbine 8. This may improve modularity of the system 100 by providing a compact form factor for the assembly 3 having the integrated turbine 8 and generator 9. A gearbox or other gear mechanism may be provided between the integrated turbine 8 and generator 9.

In some embodiments, a gear mechanism coupled between the turbine 8 and the generator 9 may facilitate uniform electricity generation across a plurality of generators 9. For example, gear mechanisms may be optimized such that the rotors of the generators 9 rotate at a consistent rate, even when water flow is spatially variable amongst the turbines 8.

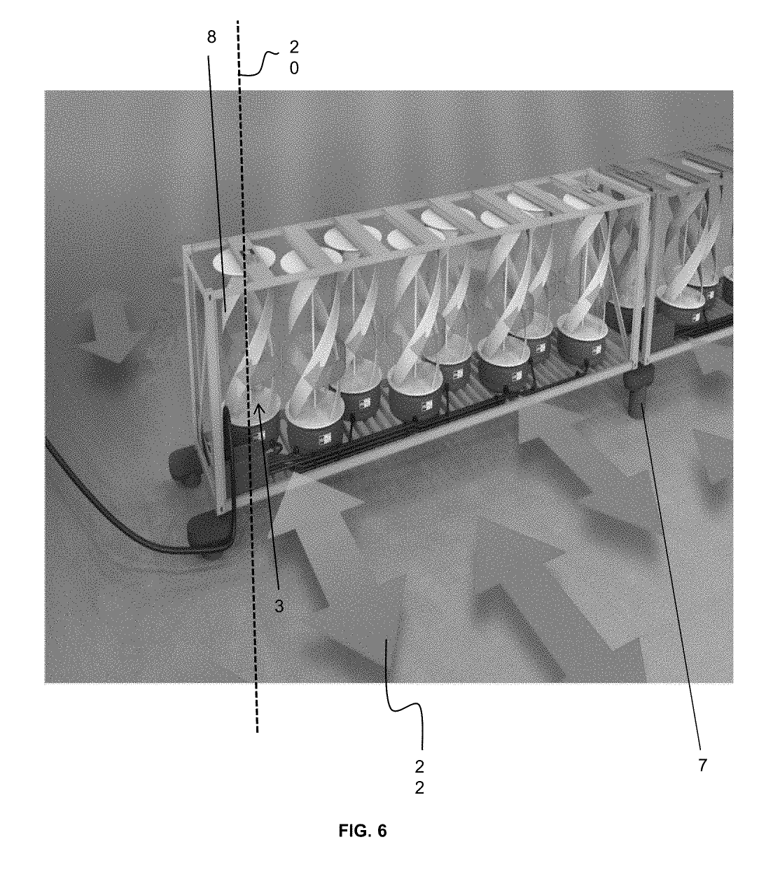

Referring back to FIG. 6, the water flow 22 causes the turbine 8 of the assembly 3 to rotate about a rotational axis 20. The rotational axis 20 may be perpendicular to the surface of the frame to which the assembly 3 is attached, and may be defined by a shaft of the turbine 8.

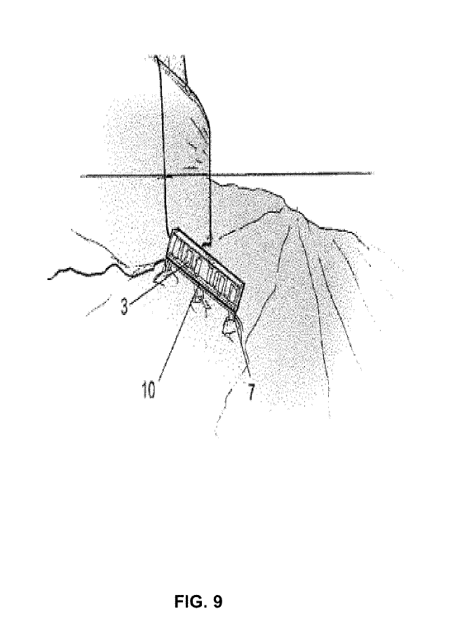

Referring now to FIG. 9, an embodiment of the system 100 is shown as a tidal power unit 10 attached to footings via the frame to footing quick connections 7 and footing caps. The tidal power unit 10 is on the sea floor near the shore and power runs from the tidal power unit 10 to shore via a wire.

As shown in FIG. 9, the tidal power unit 10 is disposed at an angle. In various embodiments, systems 100 such as the tidal power unit 10 may be disposed at various angles. For example, the tidal power unit 10 may be disposed at an angle depending on a slope or other topographical feature of the sea floor. The tidal power unit 10 may be disposed at an angle to maximize energy capture from a particular underwater region. The angles may be defined relative to a plane of the sea floor, and may range from 0 degrees to 90 degrees. In some embodiments, the system 100 includes extendable frame to footing quick connections 7 and/or extendable footing caps, allowing the angle at which the system 100 is disposed to be modified.

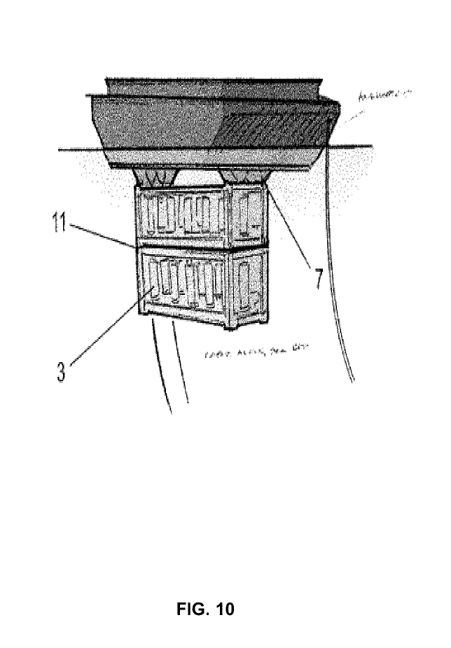

Referring now to FIG. 10, an embodiment of the system 100 is shown suspended below a barge. The system 100 may be suspended using the frame to footing quick connection 7 to attach the system to the barge. In some embodiments, a frame to frame quick connection 11 is used to secure a second system 100 to the system 100 attached to the barge. Accordingly, various systems 100 may be arranged and attached to a barge, and may be transported by the barge while suspended underwater. As shown in FIG. 10, two systems 100 are suspended below a barge using the frame to footing quick connection 7 to attach one unit to the barge and then making use of a frame to frame quick connection 11 to secure the second unit to the first.

In some embodiments, the system 100 is installed by being suspended from a moored barge. The system 100 may thus be installed without using footings. In some embodiments, attached to river or bridge abutments, or attached to mooring anchors or helixes installed in the seabed. The modularity of the system 100 facilitates deploying the system 100 in various locations otherwise inaccessible.

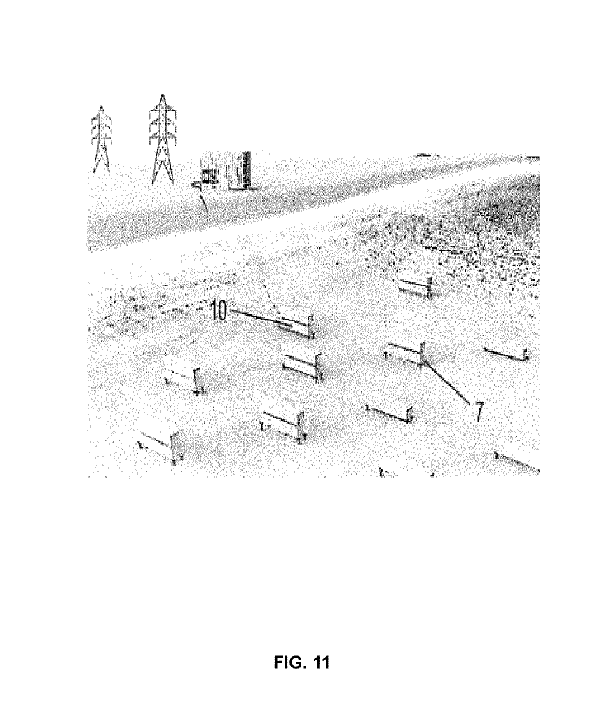

Referring now to FIGS. 11-14, various embodiments of arrangements (e.g., arrays) of systems 100 deployed are shown. Because a tidal and river current energy production unit (e.g., system 100) is modular and can easily stack, it is appropriate for both installations of a single unit but also installations where many units are placed in different kinds of arrays. Multiple systems 100 may be deployed in the same area to provide scaling for energy production. As shown in FIG. 11, a plurality of systems 100, shown as tidal power units 10, are stacked two high, and then the double units are spread across an area. Electrical connections from the units are brought together at a large junction before a single wire goes to shore. The tidal power units 10 are shown to be arrayed in rows and columns. In some embodiments, the rows and columns of the tidal power units 10 are provided in a defined grid, such as a rectangular grid. In some embodiments, the tidal power units 10 are staggered in rows and/or staggered in columns.

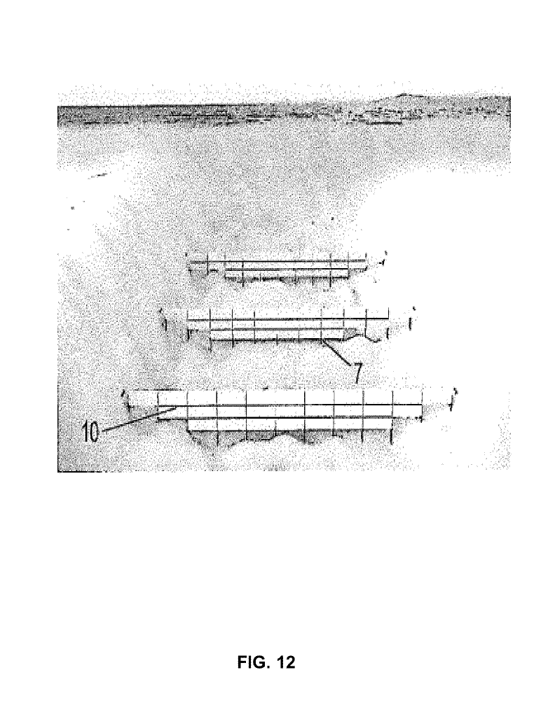

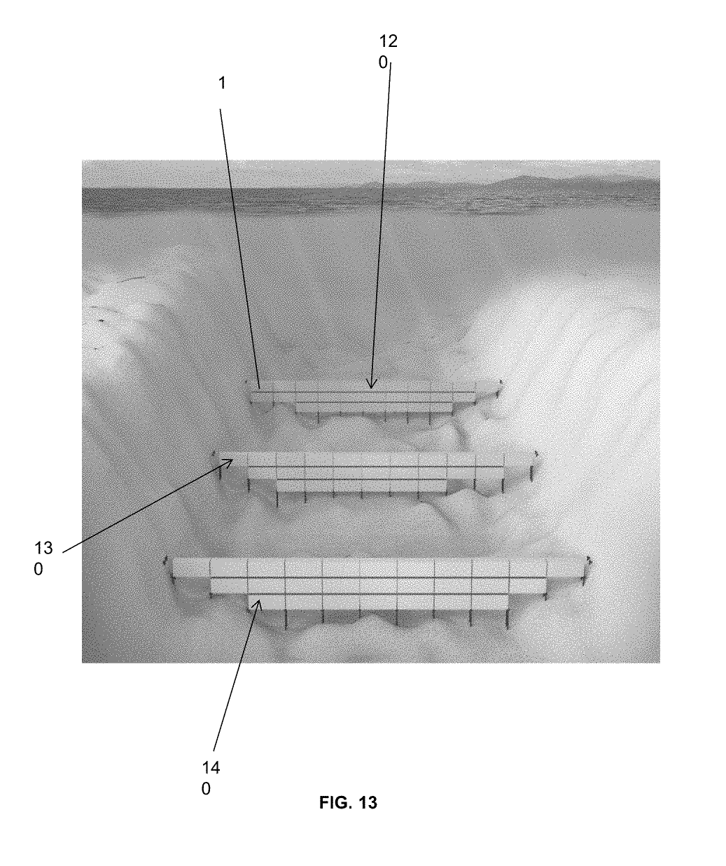

As shown in FIGS. 12-13, the systems 100 are shown as tidal power units 10 arrayed side by side and up to three high. Multiple sets 120, 130, 140 of the arrayed tidal power units 10 are placed in a channel. The frame to footing quick connection 7 is shown for securing the tidal power units 10 and thus the sets 120, 130, 140 to a floor of the channel, with footing caps accepting two tidal power units 10 side by side. In some embodiments, the sets 120, 130, 140 are oriented parallel to one another. In various embodiments, the sets 120, 130, 140 may be oriented in various configurations, such as configurations design to optimize energy production.

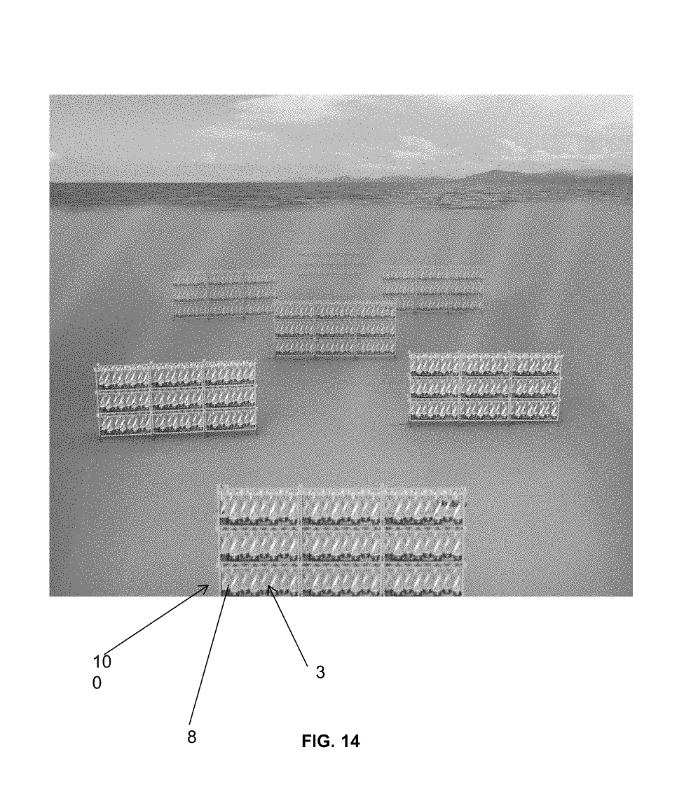

As shown in FIG. 14, a plurality of systems 100 are shown arrayed in sets of three systems 100 horizontally and three systems 100 vertically. The turbines 8 of the plurality of assemblies 3 are exposed to water flowing through the systems 100 in order to be rotated by the water flow. The sets of systems 100 are arranged in staggered rows, which may facilitate maintaining bulk water flow throughout the region occupied by the systems 100.

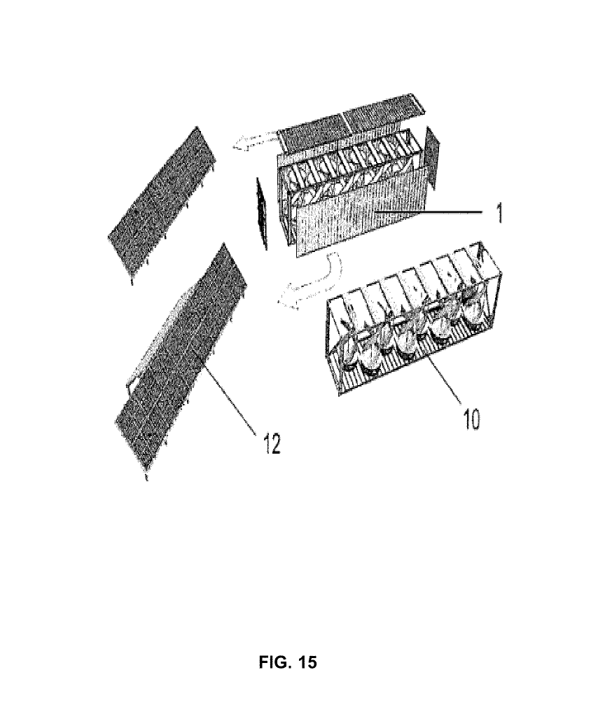

Referring now to FIG. 15, an embodiment of an arrangement of a shipping container 1 and a system 100 shown as tidal power unit 10 is shown. All parts of the shipping container 1 may be re-used. The unit in which the assemblies 3 of turbines 8 and generators 9 are installed, and which will ultimately be placed into operation, is the configuration of the shipping container 1 with the walls and roof removed. The walls and roof may be bolted on for the shipping configuration, and may be unbolted when the tidal power unit 10 is deployed at a destination.

In some embodiments, the walls and roof that are removed include solar panels, such as solar panels that are attached to the walls and roof. In some embodiments, solar panels 12 may be attached to the walls and roof after unbolting for deployment of the tidal power unit 10. In some embodiments, the walls become trays for supporting (e.g., holding up) the solar panels 12, and the roof and ends of the shipping container 1 are repurposed into supports for the trays. Accordingly, the packaging of the shipping container 1 becomes part of the tidal power unit 10, providing a flexible energy production system allowing for both hydrokinetic and solar energy production.

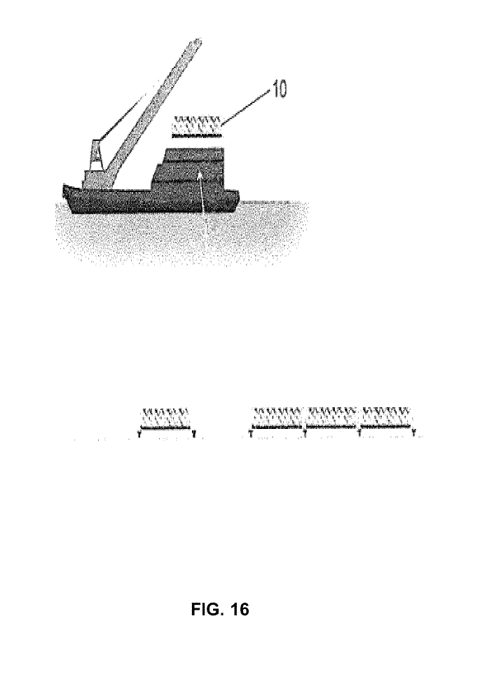

Referring now to FIG. 16, an embodiment of performing maintenance on the system 100 (shown as tidal power unit 10) is shown. In some embodiments, a vessel removes one or more tidal power units 10 in order maintenance on the one or more tidal power units. In some embodiments, maintenance is conducted on a single unit. In some embodiments, one tidal power unit 10 may be removed and maintained without affecting the ability of the remaining tidal power units 10 to generate electricity, or for the generated electricity to be transmitted to a point on shore or other destination. Accordingly, the array of tidal power units 10 shown in FIG. 10 is designed such that when a single tidal power unit 10 is removed, it does not affect the ability of the other tidal power units 10 around it to produce and transmit energy. In such embodiments, maintenance can be an ongoing operation that only has a very small impact on the energy production of the overall array.

As shown in FIG. 16, maintenance is performed on the removed tidal power unit 10 above water. In some embodiments, tidal power units 10 may be maintained underwater. For example, a diver may be send down to disconnect each tidal power unit 10 to be serviced, repaired, or otherwise maintained. Individual tidal power units 10 may be pulled from an array or rack arrangement and brought to a surface vessel, or to a shore, for cleaning and maintenance. In some embodiments, a substitute unit simultaneously rotated into the place of the removed tidal power unit 10, helping to maintain a desired energy production rate.

Maintenance may consists of service tasks including but not limited to (i) cleaning of turbine blades and end plates, (ii) renewing bearings as necessary, (iii) cleaning frames, (iv) replacing sacrificial anodes, and/or (v) plugging in a diagnostic reader to troubleshoot generators and electronics. In some embodiments, systems 100 such as the tidal power unit 10 are easily maintained in that each system 100 or subsystem thereof can be removed and replaced, and then the removed system 100 or subsystem can be reworked on shore in a workshop.

In some embodiments, the system 100 is equipped with sensors and other electronics, such as remote monitoring systems, that may periodically or constantly/continuously assess functionality of the system 100, including functionality of the turbines 8, the generators 9, the electrical connections 4, the electrical junction box 5, and/or the underwater make and break connection 6. The remote monitoring systems may also assess functionality of the system 100 in response to user inputs or user requests. The system 100 may include communications electronics allowing the system 100 to transmit diagnostic information to a remote location, such as a vessel or a location on shore, and receive communications from remote sources. The system may include a plurality of sensors detecting operation of the assemblies, generators and turbines, including any operational and performance characteristics. The system may include sensors configured to detect and measure tidal and river current parameters and conditions The system may include a processor or processing unit, such in a control system, to receive data and parameters from the sensors and/or to send commands and/or control operation of the system, such as changing parameters of the assemblies, generators and/or turbines. The system may log a number of parameters internally, and may transmit those parameters to a remote monitoring station on shore so that a remote user (e.g., a technician) may review the status of the system 100 in real-time, and may be alerted if issues are encountered. For example, a technician may review system health constantly and be alerted if issues are encountered. Monitored parameters may include water flow rates, turbine rotation rates, energy generation rates, system temperatures, etc.

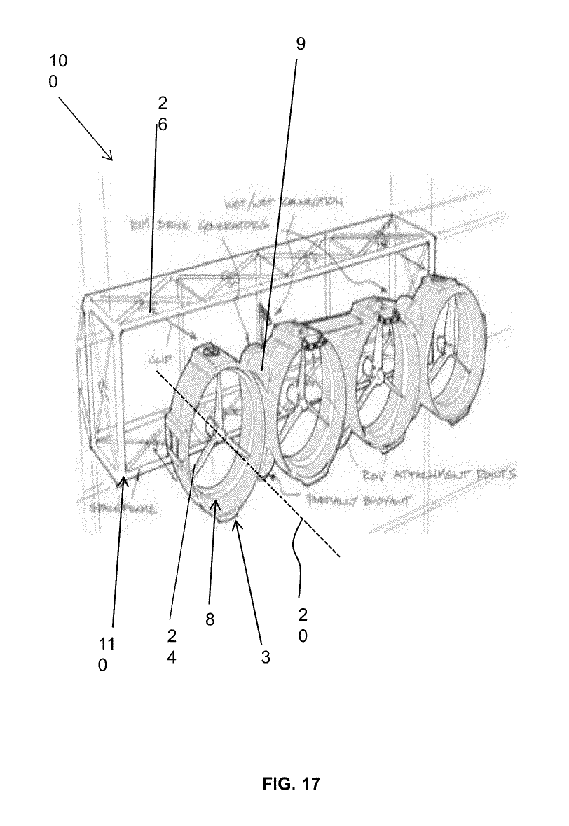

Referring now to FIGS. 17-20, an embodiment of the system 100 including axial turbines 8 is shown. The plurality of assemblies 3 includes axial turbines 8 configured to rotate about a rotational axis 20 oriented perpendicular to a direction of water flow. As shown in FIG. 17, the turbine 8 includes blades 24 extending to a rim of the assembly 3. The plurality of assemblies 3 may be attached to the frame 110 using clips 26 coupled to the frame 110. In some embodiments, the plurality of assemblies 3 include rim drive generators 9 coupled between consecutive turbines 8.

In some embodiments, the plurality of assemblies 3 having axial turbines 8 and rim drive generators 9 are provided as an integral array. For example, as shown in FIG. 17, an integral array includes a row of four axial turbines 8 with three rim drive generators disposed between consecutive axial turbines 8. The integral array of the plurality of assemblies 3 may be removably attached to the frame 110 as a group, using the clips 26.

In various embodiments, various components shown in FIGS. 17-20 may be at least partially buoyant. In such embodiments, tie lines may be coupled to the frame 110 and/or other components of the system 100 to secure the system 100 to a support structure, such as a sea floor.

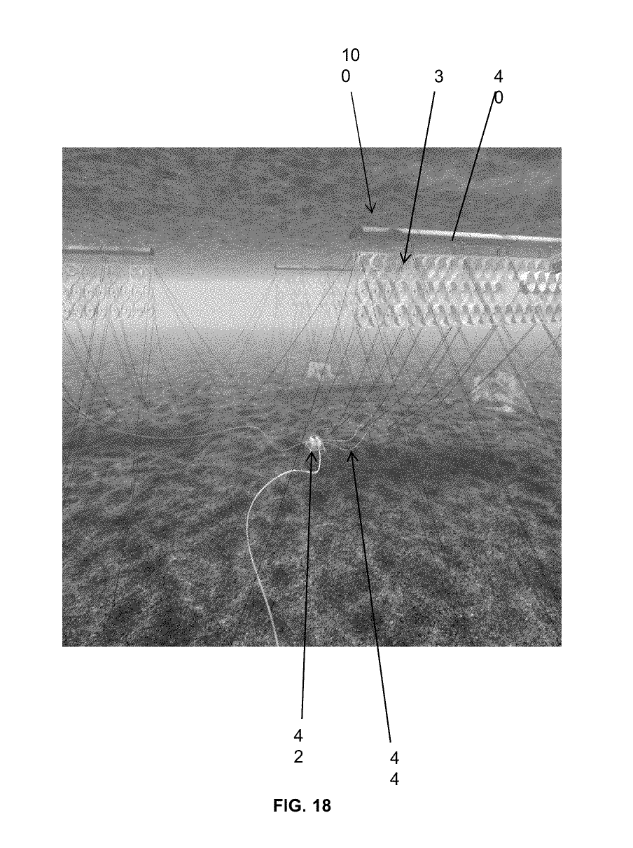

Referring further to FIG. 18, a plurality of systems 100 having axial turbines 8 are shown. The plurality of assemblies 3 may be attached to frames 110 hung from rails 40. The rails 40 may be at least partially buoyant. In some embodiments, an electrical junction 42 receives electricity generated by the plurality of assemblies 3 via electrical connections 44.

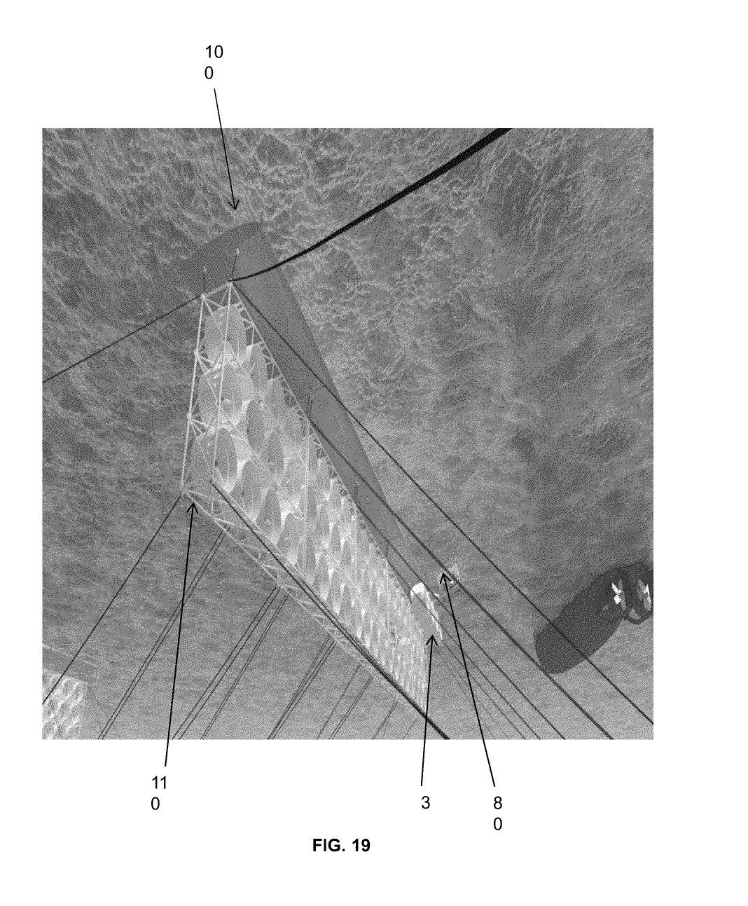

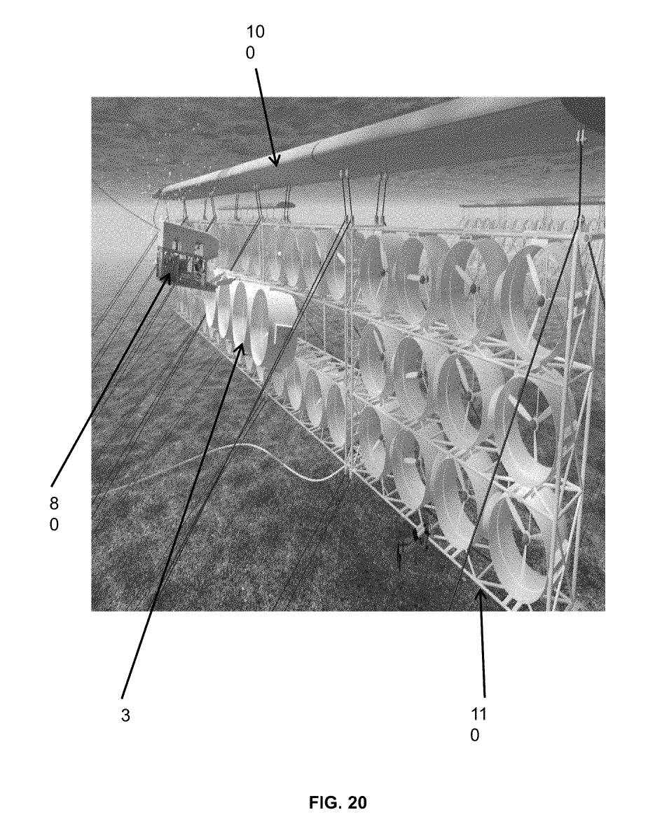

Referring further to FIGS. 19-20, a remotely operated underwater vehicle (ROV) 80 is shown. The ROV 80 is configured to install and remove the assembly 3. As shown in FIGS. 19-20, the ROV 80 may install and remove an integral array of the plurality of assemblies 3. The ROV may be partially or fully automated. For example, the ROV 80 may be configured to receive diagnostic information from the system 100, and may notify a user of the diagnostic information indicating removal or maintenance is necessary. The ROV 80 may also automatically remove or perform maintenance on the system 100 in response to an indication that removal or maintenance is necessary. Attachment points may be provided on the system 100, such as on the frame 110, to facilitate attachment of the ROV 80 to the system 100 in order to perform operations while maintaining a consistent position relative to the system 100. In some embodiments, a user may remotely control operation of the ROV 80.

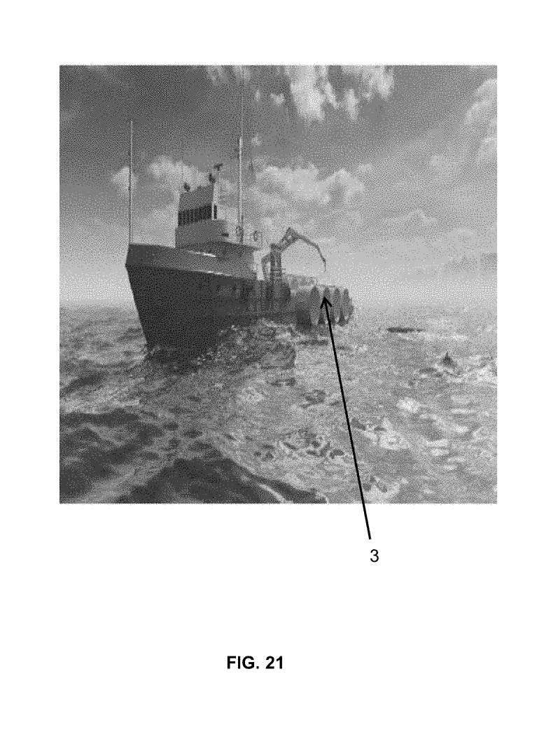

Referring now to FIG. 21, a vessel is shown deploying the plurality of assemblies 3 as an integral array. The plurality of assemblies 3 may be guided to the system 100 and installed in the system 100 by a diver or by an ROV 80. The plurality of assemblies 3 may also similarly be removed to the vessel for maintenance.

In some embodiments, components of the system 100, such as an assembly 3 or a plurality of assemblies 3, are provided as cassettes. The cassettes are configured to slide into and out of racks. For example, racks may include rail slots, and the cassettes may include rails configured to slide in and out of the rail slots. The cassettes may automatically make an electrical connection in response to sliding into the rack, and may automatically break an electrical connection in response to sliding out of the rack. An actuator may be provided to guide the cassettes into and out of the racks.

In some embodiments, the cassettes include components that are neutrally buoyant. For example, the cassettes may include turbines 8 that are neutrally buoyant and/or generators 9 that are neutrally buoyant. The assembly 3 including the turbine 8 and generator 9 may be neutrally buoyant. Controlling the buoyancy of the cassette may facilitate manipulation and transport of the cassette underwater.

In some embodiments, the system 100 is provided as buoyant racks configured to support a plurality of assemblies 3; the buoyant racks are tethered to a support structure such as a sea floor. The plurality of assemblies 3 are configured to have the form factor of an ISO shipping container. A lifting body may also be provided to augment the buoyancy

In some embodiments, the ROV 80 may be used to continuously maintain the system 100 configured to include the plurality of assemblies 3 in a rack or cassette arrangement. For example, the ROV 80 may include a communications interface configured to receive diagnostic information regarding the system 100 and the plurality of assemblies 3. The ROV 80 may be configured to process the diagnostic information to determine whether components such as the turbine 8, the generator 9, the assembly 3, or the plurality of assemblies 3 in rack or cassette form require maintenance. The ROV 80 may be configured to individually remove and replace a single turbine 8, a single generator 9, or a single assembly 3. The ROV 80 may be configured to remove a plurality of assemblies 3 provided as a rack or cassette.

The ROV 80 may be configured to process the diagnostic information to determine whether an appropriate maintenance strategy is to remove a single component (e.g., turbine 8, generator 9, assembly 3), or to remove an entire rack or cassette. For example, the diagnostic information may include levels of maintenance required; at a first level, a component may only require a low level of maintenance such that the component need not be replaced until other components in the rack or cassette also require maintenance; at a second level, a component may require a high level of maintenance (such as for preventing component failure) such that the component needs to be replaced regardless of the diagnostic status of other components. The diagnostic information may include a location of the component requiring maintenance.

In response to determining that a component of the system 100 requires maintenance, the ROV 80 is configured to travel to the system 100 to perform maintenance on the system 100. The ROV 80 may be configured to perform maintenance in situ, such as by maintaining components that are not damaged but instead may require resetting or reconnecting. The ROV 80 may be configured to acquire further diagnostic information and make a second determination as to how to perform maintenance. The ROV 80 may be configured to place the system 100 into a diagnostic mode for transmitting further diagnostic information.

In some embodiments, the ROV 80 removes a component, rack, or cassette requiring maintenance. The ROV 80 may process the diagnostic information to identify the component for removal. The system 100 may include contact points for the ROV 80 to attach to the system 100; in response to the ROV 80 attaching to the system 100, the component, rack or cassette may automatically detach from the system 100. The ROV 80 may then transport the component, rack, or cassette requiring maintenance to a remote location for maintenance. In some embodiments, the ROV 80 processes the diagnostic information to determine that a replacement component should be brought to the system 100 and replaced into the system 100 prior to transporting the component, rack, or cassette requiring maintenance to the remote location. In some embodiments, the ROV 80 processes the diagnostic information to determine to first transport the component, rack, or cassette requiring maintenance to the remote location, and then transporting the replacement component, rack, or cassette to the system 100 for replacement. In some embodiments, the ROV 80 has access to a store for components, racks, and cassettes, and the ROV 80 can cycle components, racks, and cassettes into and out of the store as necessary for maintenance operations.

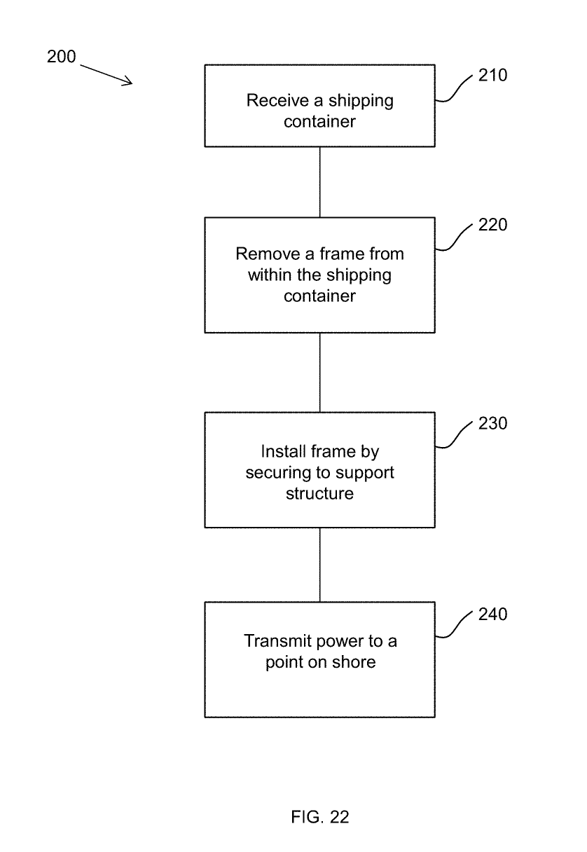

Referring now to FIG. 22, a method 200 is shown for deploying, operating, and generating energy using a system for hydrokinetic energy production (e.g., system 100). The method and steps therein may be performed by a vessel, such as a barge; by a user controlling the vessel; by a user operating the system; by an ROV (e.g., ROV 80), etc.

At 210, a shipping container is received. The shipping container includes a frame having a plurality of assemblies attached to a surface of the frame. Each assembly of the plurality of assemblies includes a generate and a turbine coupled to the generator. The generator is configured to generate electricity in response to rotation of the turbine.

At 220, the frame is removed from within the shipping container by removing one or more walls of the shipping container. In some embodiments, the one or more walls are removed above water, such as before the frame is deployed underwater. In some embodiments, one or more walls are removed underwater.

At 230, the frame is installed at least partially underwater by securing the frame to a support structure using a connection mechanism. Water flowing through the turbine of each of the assemblies causes rotation of the turbine and generation of electricity. In some embodiments, securing the frame to the support structure using the connection mechanism includes suspending the frame from a barge underwater. In some embodiments, securing the frame to the support structure using the connection mechanism includes attaching the frame to at least one of a river abutment, a bridge abutment, mooring anchors, or helixes installed in a sea bed. In some embodiments, securing the frame to the support structure includes securing the connection mechanism to footing caps installed on the sea floor. In some embodiments, installing the frame further includes positioning the frame subject to at least one of tidal or current flow. In some embodiments, multiple frames are secured in an arrangement such as an array, by using frame to footing quick connections and/or frame to frame quick connections.

At 240, power is transmitted to a point on shore. The power is generated by the generator of each of the plurality of assemblies and transmitted via an electrical junction box and an underwater make and break connection. The underwater make and break connection may be coupled to the electrical junction box after the frame is installed underwater, which may allow the frame to be installed in an existing arrangement.

The systems and components thereof described herein (e.g., systems 100, etc.) may be constructed from a variety of different materials. In various embodiments, various materials may be used that provide sufficient structural rigidity for a particular application. In some embodiments, materials used may include metals (e.g., aluminum, steel, stainless steel, titanium, magnesium, etc.), plastics (nylon, glass-filled nylon, acetal, polypropylene, ABS, etc.), composites (carbon fiber), resins, etc. The materials may be selected based on deployment location. For example, materials with relatively high resistance to corrosion or other salt water damage may be selected for sea and ocean applications.

Fabrication and assembly of the components may be accomplished using a wide variety of established manufacturing techniques including machining, molding, casting, extruding, forging, laminating, fastening, and welding.

It should be noted that the orientation of various elements may differ according to other exemplary embodiments, and that such variations are intended to be encompassed by the present disclosure. It is recognized that features of the disclosed embodiments can be incorporated into other disclosed embodiments.

It is important to note that the constructions and arrangements of apparatuses or the components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to some embodiments. Other substitutions, modifications, changes and omissions may also be made in the design, operating conditions and arrangement of the various exemplary embodiments without departing from the scope of the present disclosure.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, describes techniques, or the like, this application controls.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of and “consisting essentially of shall be closed or semi-closed transitional phrases, respectively, as set forth in the United States Patent Office Manual of Patent Examining Procedures, Section 2111.03.

What is claimed is:

1. A system comprising:
a shipping container holding a frame; and
a plurality of assemblies attached to a surface of the frame, each assembly of the plurality of assemblies including a generator and a turbine coupled to the generator, the generator configured to generate electricity in response to rotation of the turbine; and
wherein one or more walls of the shipping container are removable to remove the frame from within the shipping container.

2. The system of claim 1, wherein the frame is further configured to be removed from the shipping container and installed securely underwater to a sea floor and to generate power via water flowing through the turbine of each of the plurality of assemblies.

3. The system of claim 2, wherein the frame further comprises a frame to footing connection mechanism to connect the frame to footing caps installed on the sea floor.

4. The system of claim 3, wherein the footing caps are configured to be attached to pilings.

5. The system of claim 2, wherein the frame further comprises an underwater make and break electrical connection and an electrical junction box to transmit power generated by the generator of each of the plurality of assemblies to a point on shore.

6. The system of claim 5, wherein each assembly is further configured to be modular and removable such that the electrical junction box receives power from the plurality of assemblies independent of one another.

7. The system of claim 1, wherein the frame further comprises a plurality of vertical members coupled to a plurality of horizon members, one or more diagonal struts along one or more ends of the frame and one or more upper supports to hold the plurality of assemblies in place within the frame.

8. The system of claim 1, wherein the assemblies are one of vertically or horizontally oriented within the frame.

9. The system of claim 1, wherein the turbine comprises one of a cross flow turbine or an axial turbine.

10. The system of claim 1, wherein the frame is further configured to be removed from the shipping container and suspended from a barge underwater to generate power via water flowing through the turbine of each of the plurality of assemblies.

11. The system of claim 1, wherein the frame is further configured to be removed from the shipping container and installed at least partially underwater from one of a bottom of a moored barge, attached to a river abutment, attached to a bridge abutment, attaching to mooring anchors or attached to helixes installed in the sea bed.

12. A method comprising:
receiving a shipping container comprising a frame having a plurality of assemblies attached to a surface of the frame, each assembly of the plurality of assemblies including a generator and a turbine coupled to the generator, the generator configured to generate electricity in response to rotation of the turbine;
removing the frame from within the shipping container by removing one or more walls of the shipping container; and
installing the frame at least partially underwater by securing the frame to a support structure using a connection mechanism, wherein water flowing through the turbine of each of the assemblies causes rotation of the turbine and generation of electricity.

13. The method of claim 12, wherein securing the frame to the support structure using the connection mechanism includes suspending the frame from a barge underwater.

14. The method of claim 12, wherein securing the frame to the support structure using the connection mechanism includes attaching the frame to at least one of a river abutment, a bridge abutment, mooring anchors, or helixes installed in a sea bed.

15. The method of claim 12, wherein securing the frame to the support structure includes securing the connection mechanism to footing caps installed on the sea floor.

16. The method of claim 12, further comprising transmitting power generated by the generator of each of the plurality of assemblies to a point on shore via an electrical junction box and an underwater make and break electrical connection.

17. The method of claim 16, further comprising detaching an assembly from the frame and continuing to transmit power generated by the generators of the remaining assemblies.

18. The method of claim 12, wherein installing the frame further includes positioning the frame subject to at least one of tidal or current flow.

19. The method of claim 12, wherein the turbine comprises one of a cross flow turbine or an axial turbine.

20. The method of claim 12, wherein the assemblies are one of vertically or horizontally oriented within the frame.
